(19) United States
(12) Patent Application Publication
(10) Pub. No.: US 2022/0014056 A1
(43) Pub. Date: Jan. 13, 2022

(54) ELECTRIC ROTATING MACHINES WITH INCREASED FLUX DENSITY

(71) Applicant: National Oilwell Varco, L.P., Houston, TX (US)

(72) Inventors: Geoffrey PICKETT, Sugar Land, TX (US); Moadh MALEK, Houston, TX (US)

(21) Appl. No.: 17/293,805

(22) PCT Filed: Nov. 13, 2019
(86) PCT No.: PCT/US19/61184

§ 371 Date: May 13, 2021

Related U.S. Application Data
(60) Provisional application No. 62/760,762, filed on Nov. 13, 2018.

(51) Int. Cl. H02K 1/27; H02K 1/17

(52) U.S. Cl. CPC H02K 1/278; H02K 2213/03; H02K 1/2773; H02K 1/17

(57) ABSTRACT

An electric rotating machine includes a housing, a stator, and a rotor. The stator is disposed within the housing. The rotor is disposed within the housing and magnetically coupled to the stator. The rotor includes a plurality of permanent magnets attached to an outer surface of the rotor. The magnets are disposed to form a Halbach array, and the magnets are configured to provide a magnet ratio in a range of 0.7 to 0.9.

### CROSS-REFERENCE TO RELATED APPLICATION

The present application is a national stage application of PCT/US2019/061184, filed Nov. 13, 2019, entitled “Electric Rotating Machines with Increased Flux Density,” which claims priority to U.S. Provisional Patent Application No. 62/760,762, filed Nov. 13, 2018, entitled “Advanced Rotor Construction Increased Flux Density in Electro-Mechanical Rotating Machines,” which is hereby incorporated herein by reference in its entirety.

### BACKGROUND

Electric rotating machines, such as electric motors and generator are used in a wide variety of applications. Electric rotating machines operate based on an induction principle, wherein magnetic flux generated between a stationary stator and a rotating rotor is produced through induction. Current passes through the stator at a given frequency and induces a magnetic current in the rotor. In the most modern implementations, the magnetic field emanating from the rotor is produced by imbedded permanent magnets.

### SUMMARY

In one example, an electric rotating machine includes a housing, a stator, and a rotor. The stator is disposed within the housing. The rotor is disposed within the housing and magnetically coupled to the stator. The rotor includes a plurality of permanent magnets attached to an outer surface of the rotor. The magnets are disposed to form a Halbach array, and the magnets are configured to provide a magnet ratio in a range of 0.5 to 0.9 or 0.7 to 0.9.

In another example, an electric motor includes a stator and a rotor. The rotor is disposed at least partially within the stator, and include a plurality of surface permanent magnets. The surface permanent magnets are disposed to form a Halbach array, and the surface permanent magnets are configured to provide a magnet ratio in a range of 0.5 to 0.9 or 0.7 to 0.9.

In a further example, an electric rotating machine includes a stator and a rotor. A thermally conductive encapsulation material is disposed in and about the stator. The rotor is magnetically coupled to the stator, and includes a plurality of permanent magnets attached to an outer surface of the rotor. The magnets are disposed to form a Halbach array, and for each pole of the rotor a ratio of pole-arc of a mid-magnet segment to pole-pitch is in a range of 0.5 to 0.9 or 0.7 to 0.9.

### BRIEF DESCRIPTION OF THE DRAWINGS

For a detailed description of various examples, reference will now be made to the accompanying drawings in which:

FIG. 1 shows an example rotor that includes interior permanent magnets suitable for use in an electric rotating machine;

FIG. 2 shows an example rotor that includes surface permanent magnets suitable for use in an electric rotating machine;

FIG. 3 shows an example magnet array in which the magnets are arranged in a north-south orientation;

FIG. 4 shows an example magnet array in which the magnets are arranged as a Halbach array;

FIG. 5 shows an example electric rotating machine in accordance with the present disclosure;

FIG. 6 shows a comparison of magnetic flux density in a non-Halbach surface permanent magnet machine (SPM) and a conventional Halbach SPM machine;

FIG. 7 shows a comparison of magnetic flux density in a non-Halbach surface permanent magnet machine (SPM) and a Halbach SPM machine having a magnet ratio selected in accordance with the present disclosure;

FIG. 8 shows a comparison of flux density in the air gap of an electric rotating machine for various magnet ratio values; and

FIG. 9 shows a comparison of torque provided by an electric rotating machine using various configurations of an array of SPMs with different magnet ratios.

### DETAILED DESCRIPTION

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . .” Also, the term “couple” or “couples” is intended to mean either a direct or indirect connection. Thus, if a first device couples to a second device, that connection may be through a direct connection or through an indirect connection via other devices and connections. The recitation “based on” is intended to mean “based at least in part on.” Therefore, if X is based on Y, X may be a function of Y and any number of other factors.

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Flux density and flux linkage are two important consideration in electric rotating machine design. Those two principles determine much of the power density and performance of motors, generators, or other electric rotating machines. Some electrical machines operate on an induction principle, in which the flux generated between a stationary stator, which generally deploys copper to create a magnetic field, and a rotating rotor is produced through induction. Current passes through the stator at a given frequency to induce a magnetic current in the rotor. These machines typically use copper because copper is highly conductive and non-ferrous. Such machines can conduct relatively high currents and alternate between positive and negative very quickly to change the magnetic field relative to the rotor. The rotors of such machines also include copper and maintain a fixed magnetic field that is induced, hence the term “induction motor.”

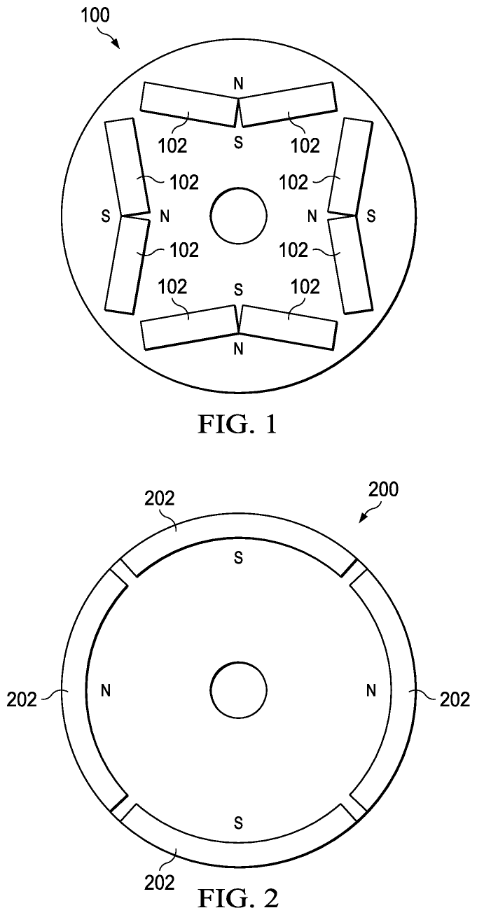

In most modern electric rotating machines, the magnetic field emanating from the rotor is produced by permanent magnets (PMs). PM machines use magnets instead of copper in the rotor. PM machines provide increased efficiency because there are no copper losses in the rotor, and have, for this reason, been widely adopted. For manufacturing purposes, ease of construction, and simplicity, most PM machines embed the magnets inside the rotor. FIG. 1 shows an example rotor 100 that includes interior permanent magnets (IPMs) 102 arranged in a V. Other implementations of the rotor 100 include the IPMs 102 arranged in a W shape. In the rotor 100, the magnetic fields are strongest at the edges of the rotor 100. Because the goal is to increase flux density near the edge of the rotor, this technique is commonly employed.

Surface permanent magnet (SPM) machines arrange the PMs on the surface of the rotor, rather than within the rotor. The PMs may unusually shaped and more difficult to deploy and manufacture than the magnets used as IPMs. For this reason, even though the magnetic field of the SPM rotor is closer to the edge of the rotor and the air-gap stator interaction, SPMs less frequently implemented. FIG. 2 shows an example rotor 200 that includes SPMs 202.

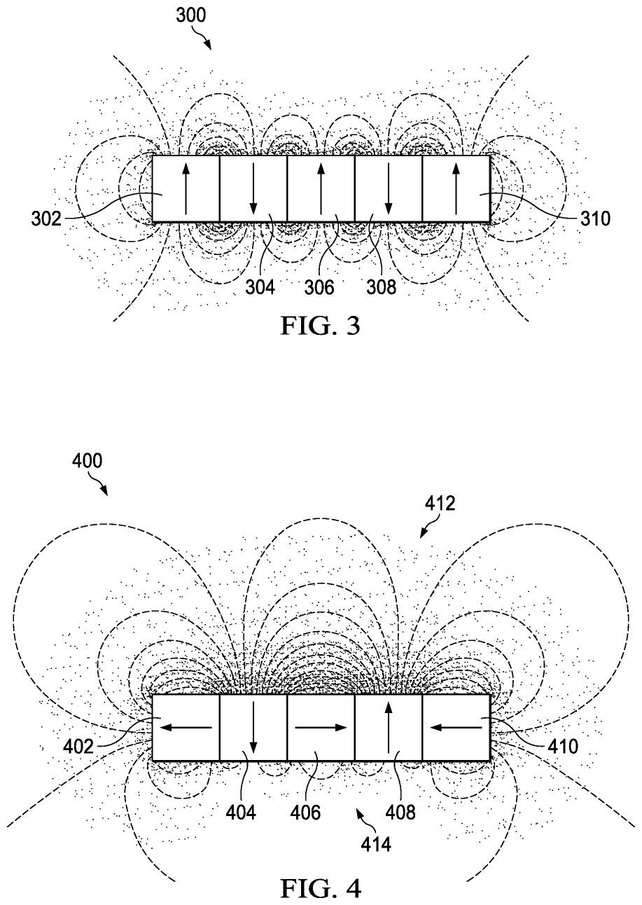

FIG. 3 shows an example magnet array 300 in which the magnets 302-310 are arranged in a north-south orientation. The magnets, 302, 306, and 310 are oriented in one direction, and the magnets 304 and 308 are oriented in the opposite direction. In a Halbach array, the magnets are not arranged in a north-south orientation or alternating polarity as in the magnet array 300. Rather, in a Halbach array, the magnets are arranged in a north-east-south-west orientation that pushes the flux of the array in one direction. Because flux density and linkage are important to increasing performance in electric rotating machines, the Halbach array is very advantageous.

FIG. 4 shows an example Halbach array 400. The Halbach array 400 includes magnets 402-410, where each successive magnet is rotated 90° counterclockwise with respect to the previous magnet (e.g., magnet 404 is rotated 90° counterclockwise with respect to magnet 402, magnet 406 is rotated 90° counterclockwise with respect to magnet 406, etc.). This arrangement increases the magnet flux on side 412 of the of the Halbach array 400, and decreases the magnetic flux on the side 414 of the Halbach array 400.

The reduction of magnetic flux on the side 414 of the Halbach array 400 provides an advantage in construction of an electric rotating machine. In a circular rotor, the inward magnetic flux can create magnetic saturation effects. If the rotor goes beyond saturation, the magnets in the motor can be demagnetized and the machine will cease to function. As a result, mass in the form of laminates is added in some implementations to absorb the flux and inhibit saturation. With a Halbach array, the flux strength in the radially inward direction is reduced, so rotor mass and inertia can be reduced.

However, Halbach arrays do have some disadvantages. First, the rotor cannot be magnetized in a typical manner. For instance, manufacturers place non-magnetized PM material in the rotor that is easy and safe to handle. Manufacturers then apply a highly dense magnetic field to the machine to magnetize the rotor. The unusual orientation of Halbach arrays prevents that from happening. For a Halbach array, a manufacturer would have to manually orient the magnets individually in place while the magnets are magnetized. The magnets want to flip to a standard north-south or alternating polarity, making manufacturing difficult.

Furthermore, Halbach arrays diminish performance of IPM machines. In a standard IPM design, the edges of the V or W arranged magnets are nearest the surface, because the ends of the magnets have the greatest flux near the edge. The edge effects, which can be seen in FIG. 3, are significant compared to a Halbach array. Simply reorienting an IPM machine weakens the flux near the edge of the rotor and near the air gap.

The electric rotating machines disclosed herein enhance the magnetic field emanating from the rotor, by applying surface permanent magnets (SPMs) rather than IPMs. The SPMs are arranged in a Halbach array, and the Halbach array is configured to provide a magnet ratio selected to increase the flux in the airgap separating the rotor and stator. With the increased flux, the electric rotating machines of the present disclosure provide higher torque than equivalently sized conventional SPM machines.

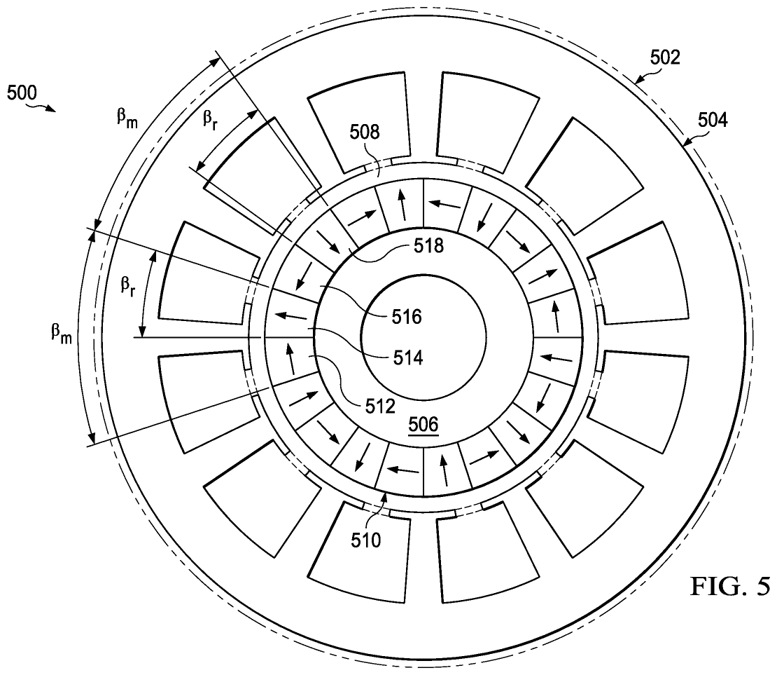

FIG. 5 shows an example electric rotating machine 500 in accordance with the present disclosure. The electric rotating machine 500 includes a housing 502, a stator 504, and rotor 506. The stator 504 and the rotor 506 are disposed within the housing 502. The rotor 506 is disposed at least partially with, and is magnetically coupled to the stator 504. An air gap 508 separates the stator 504 and the rotor 506. The rotor 506 includes an array of SPMs 510. The array of SPMs 510 includes magnets 512-518 arranged as a Halbach array. The Halbach array concentrates magnetic flux radially outward from the rotor 506. The magnets 512-518 of the array of SPMs 510 configured in a way that increases magnetic flux in the air gap 508, and in turn increases flux linkage, relative to other Halbach array implementations, conventional SPM implementations, and/or IPM implementations.

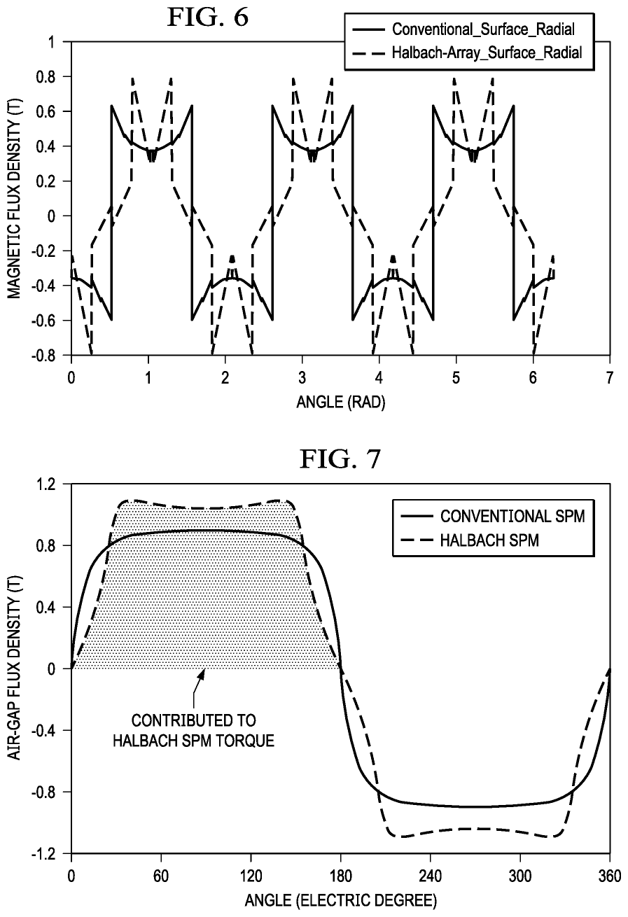

Simply implementing a Halbach array on either an SPM array or an IPM array will not increase the performance of an electric rotating machine. In an IPM machine, a Halbach array decreases performance due to edge effects and flux leakage inside the rotor. Similarly, implementation of a Halbach array may not provide a performance increase over a convention array of SPMs. FIG. 6 shows a comparison of magnetic flux density in a non-Halbach SPM machine and a conventional Halbach SPM machine. FIG. 6 shows that the peak torque in the conventional Halbach SPM machine is too high, and total performance, as measured by the area under the curve, is reduced relative to the non-Halbach SPM machine. In contrast to the results of FIG. 6, implementations of the Halbach array in SPMs 510 produces torque as shown in FIG. 7, which does provide an improvement over conventional SPM configurations.

In a conventional Halbach array, each of the magnets has the same magnetic strength. Implementations of the array of SPMs 510 produce greater flux (e.g., 12% more flux) than conventional Halbach arrays by changing the volume or strength of the magnets 512-518. In the array of SPMs 510, the magnet 512 and the magnet 516 (i.e., the “end” magnets) are weaker than the magnet 514 and the magnet 518 (i.e., the “mid” magnet segments). For example, the sizes of the magnets 512-518 are selected to produce a desired magnet ratio, where the magnet ratio (Rₘₚ) is expressed as:

$${R}_{mp} = \frac{{β}_{r}}{{β}_{m}}$$

and where:
βᵣ is the pole arc of the 514 or the 518 as shown in FIG. 5; and
βₘ is the pole pitch of a single pole as shown in FIG. 5.

Implementations of the array of SPMs 510 may include magnets 512-518 selected to provide a magnet ratio in a range of 0.5 to 0.9 or 0.7 to 0.9. Various implementations of the array of SPMs 510 may include magnets 512-518 selected to provide a magnet ratio in a range of 0.725 to 0.875, a magnet ratio in a range of 0.75 to 0.85, a magnet ratio in a range of 0.775 to 0.825, a magnet ratio of 0.8, or a magnet ratio of about 0.8.

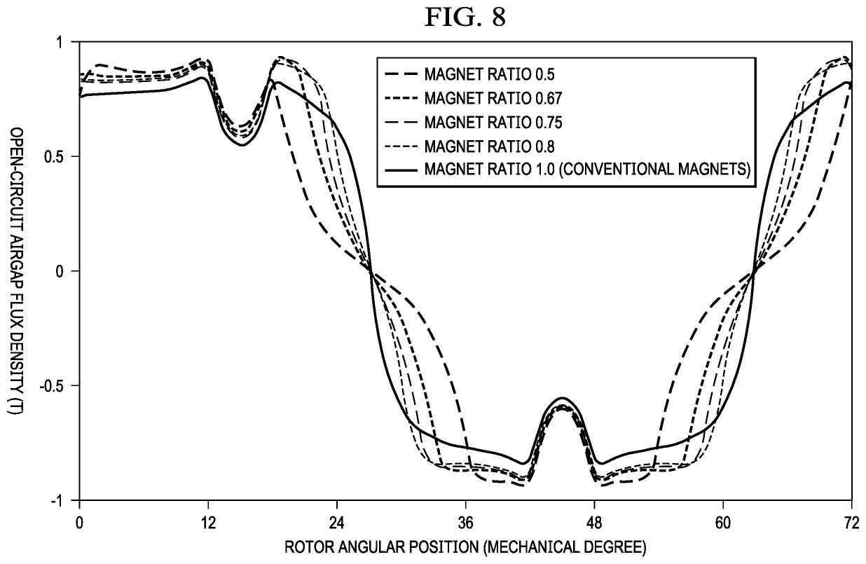

FIG. 8 shows a comparison of flux density in the air gap 508 for various magnet ratio values. In FIG. 8, a magnet ratio of 1.0 corresponds to a conventional SPM arrangement, and a magnet ratio of 0.5 corresponds to a conventional Halbach SPM arrangement (e.g., all magnets of equal size).

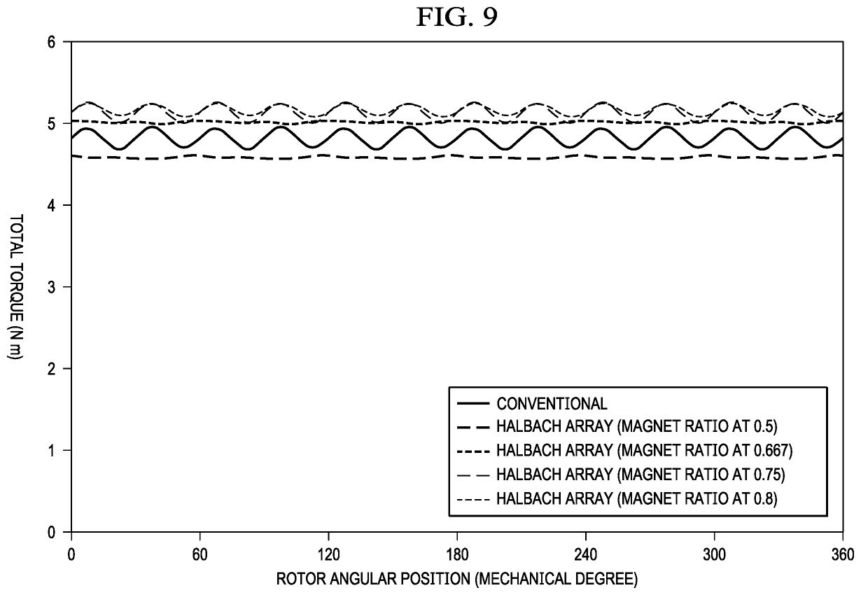

FIG. 9 shows a comparison of torque provided by the electric rotating machine 500 using various configurations of the array of SPMs 510 with different magnet ratios. FIG. 8 shows a magnet ratio of 0.8 provides the highest torque, which is about 10% higher than the torque generated by a conventional SPM.

Some implementations of the electric rotating machine 500 encapsulate the stator 504 and fill the space between the stator 504 and the housing 502 with a thermally conductive encapsulation material. For example, the stator end windings, the stator slots, and the area between the stator 504 and the housing 502 may be encapsulated and filled with the thermally conductive encapsulation material. The thermally conductive encapsulation material conducts heat from the stator 504 and the rotor 510 to the housing 502 to reduce the operating temperature of the electric rotating machine 500 relative to an electric rotating machine without encapsulation. The temperature reduction can extend the life of the electric rotating machine 500 by reducing temperature related stress on insulation materials and providing protection from external contaminants. Additionally, the increased heat conduction provided by the thermally conductive encapsulation material may allow the electric rotating machine 500 to operate with higher power or be reduced in size. For example, because of the more efficient heat removal provided by the thermally conductive encapsulation material an implementation of the electric rotating machine 500 with encapsulation material about the stator 504 may operate at a higher power than a same-sized electric rotating machine that lacks stator encapsulation. In some implementations of the electric rotating machine 500, a 202xxx epoxy from EPI POLYMERS INC. or other thermally conductive material may be applied to encapsulate the stator 504.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An electric rotating machine, comprising:
a housing;
a stator disposed within the housing; and
a rotor disposed within the housing and magnetically coupled to the stator, the rotor comprising a plurality of permanent magnets attached to an outer surface of the rotor; wherein:
the magnets are disposed to form a Halbach array; and
the magnets are configured to provide a magnet ratio in a range of 0.7 to 0.9.

2. The electric rotating machine of claim 1, wherein the magnets are configured to provide a flux in a radial direction.

3. The electric rotating machine of claim 1, wherein the magnet ratio is a ratio of a pole-arc of a mid-magnet segment to a pole-pitch of a single pole.

4. The electric rotating machine of claim 1, wherein the magnets are configured to provide a magnet ratio in a range of 0.725-0.875.

5. The electric rotating machine of claim 1, wherein the magnets are configured to provide a magnet ratio in a range of 0.75-0.85.

6. The electric rotating machine of claim 1, wherein the magnets are configured to provide a magnet ratio in a range of 0.775-0.825.

7. The electric rotating machine of claim 1, wherein the magnets are configured to provide a magnet ratio of 0.8.

8. An electric motor, comprising:
a stator; and
a rotor disposed at least partially within the stator, and comprising a plurality of surface permanent magnets; wherein:
the surface permanent magnets are disposed to form a Halbach array; and
the surface permanent magnets are configured to provide a magnet ratio in a range of 0.7 to 0.9.

9. The electric motor of claim 8, wherein the surface permanent magnets are configured to provide a flux in a radial direction.

10. The electric motor of claim 8, wherein the magnet ratio is a ratio of a pole-arc of a mid-magnet segment to a pole-pitch of a single pole.

11. The electric motor of claim 8, wherein the surface permanent magnets are configured to provide a magnet ratio in a range of 0.725-0.875.

12. The electric motor of claim 8, wherein the surface permanent magnets are configured to provide a magnet ratio in a range of 0.75-0.85.

13. The electric motor of claim 8, wherein the surface permanent magnets are configured to provide a magnet ratio in a range of 0.775-0.825.

14. The electric motor of claim 8, wherein the surface permanent magnets are configured to provide a magnet ratio of 0.8.

15. An electric rotating machine, comprising:
a stator;
a thermally conductive encapsulation material disposed in and about the stator; and
a rotor magnetically coupled to the stator, the rotor comprising a plurality of permanent magnets attached to an outer surface of the rotor; wherein:
the magnets are disposed to form a Halbach array; and
for each pole of the rotor a ratio of pole-arc of a mid-magnet segment to pole-pitch is in a range of 0.7 to 0.9.

16. The electric rotating machine of claim 15, wherein the magnets are configured to provide a flux in a radial direction.

17. The electric rotating machine of claim 15, wherein for each pole of the rotor a ratio of pole-arc of a mid-magnet segment to pole-pitch is in a range of 0.725-0.875.

18. The electric rotating machine of claim 15, wherein for each pole of the rotor a ratio of pole-arc of a mid-magnet segment to pole-pitch is in a range of 0.75-0.85.

19. The electric rotating machine of claim 15, wherein for each pole of the rotor a ratio of pole-arc of a mid-magnet segment to pole-pitch is in a range of 0.775-0.825.

20. The electric rotating machine of claim 15, wherein for each pole of the rotor a ratio of pole-arc of a mid-magnet segment to pole-pitch is 0.8.
